(19) United States
(12) Patent Application Publication
(10) Pub. No.: US 2003/0182333 A1
(43) Pub. Date: Sep. 25, 2003

(54) Method and user interface for entering, plotting and analyzing data on a handheld device

(76) Inventors: John C. Good, Greenfield, NH (US); Shawn Prestridge, Plano, TX (US)

Correspondence Address: TEXAS INSTRUMENTS INCORPORATED, P O BOX 655474, M/S 3999, DALLAS, TX, 75265

(21) Appl. No.: 10/102,497

(22) Filed: Mar. 19, 2002

(51) Int. Cl. G06F 1/00

(52) U.S. Cl. 708/131

(57) ABSTRACT

An improved user interface for a handheld computing device to help a student to easily enter, plot and analyze data such as that on a list. The invention introduces a “wizard” approach user interface that smoothly guides the user through a sequential process of: entering data in one or more lists, viewing the data graphically using one of several common plots, viewing one or more regression functions to fit the data, and analyzing the data using common statistical measures. The user interface brings together some sophisticated graphing tools into a common tool with a simple interface. Thus the present invention allows a user to perform basic list functions with these sophisticated tools with a minimum of experience. An embodiment of the present invention is an application program on a graphing calculator or other computer, which allows the user to display and modify a two dimensional grid of real-time data. Similarly, other embodiments include the same user interface functionality in a ROM software application package that is executed on a graphing calculator or other handheld device.

### TECHNICAL FIELD OF THE INVENTION

This invention relates to hand-held electronic computing devices and software on those devices, and more particularly to a calculator that includes a user interface and method for entering, plotting and analyzing data on a handheld device or other device with a limited display screen.

### BACKGROUND OF THE INVENTION

Electronic calculators have become a common tool for teaching students mathematics. In particular, the advantages of graphing calculators are being utilized in the classroom. Graphing calculators are characterized by a larger screen, which permits the entry of mathematical expressions in a logical format. They also permit graph displays and table displays. They have sophisticated programming capability. They often permit data transmission to other computing devices, directly or via a data storage medium, as well as data collection via various interface protocols.

Particular calculator models are often designed for particular educational levels. For example, a calculator for middle school students might have less advanced features than one designed for older students. However, regardless of the level for which a calculator is designed, a continual goal in designing them is to provide a logical and easy to use interface. Another goal of the user interface is to assist the teacher in instructing students in the classroom environment.

### SUMMARY OF THE INVENTION

The present invention seeks to help a student to easily enter, plot and analyze data such as that on a list. Prior art calculators and software allowed the student to analyze and plot data from a list, however, the sequence of steps to accomplish this task was difficult such that only expert users could perform this type of operation. A disclosed embodiment is a user interface and method, which is particularly directed to helping a student in a classroom environment to quickly and easily enter, plot and analyze data. The invention is applicable and useful or other computer devices such as personal computers, personal data assistance and other hand held electronic devices. The invention introduces a “wizard” approach user interface that smoothly guides the user through a sequential process of: entering data in one or more lists, viewing the data graphically using one of several common plots, viewing one or more regression functions to fit the data, and analyzing the data using common statistical measures. The user interface brings together some sophisticated graphing tools into a common tool with a simple interface. Thus the present invention allows a user to perform basic list functions with these sophisticated tools with a minimum of experience.

An embodiment of the present invention is an application program on a graphing calculator or other computer, which allows the user to display and modify a two dimensional grid of real-time data. Similarly, other embodiments include the same user interface functionality in a ROM software application package that is executed on a graphing calculator or other handheld device. The calculator in the present invention may otherwise be a conventional graphing calculator.

### BRIEF DESCRIPTION OF THE DRAWINGS

FIG. 1 illustrates the front panel of a prior art calculator 10 which incorporates the invention.

FIGS. 2a-f illustrates the initial menu display and the data entry/edit function according to the present invention.

FIGS. 3a-k illustrates the screen displays for the plot function according to the present invention.

FIGS. 4a-c illustrate the screen displays for the fitting a graph to a regression function according to an embodiment of the present invention.

FIGS. 5a-c illustrate the screen displays for the analyze data function according to an embodiment of the present invention.

### DETAILED DESCRIPTION OF THE INVENTION

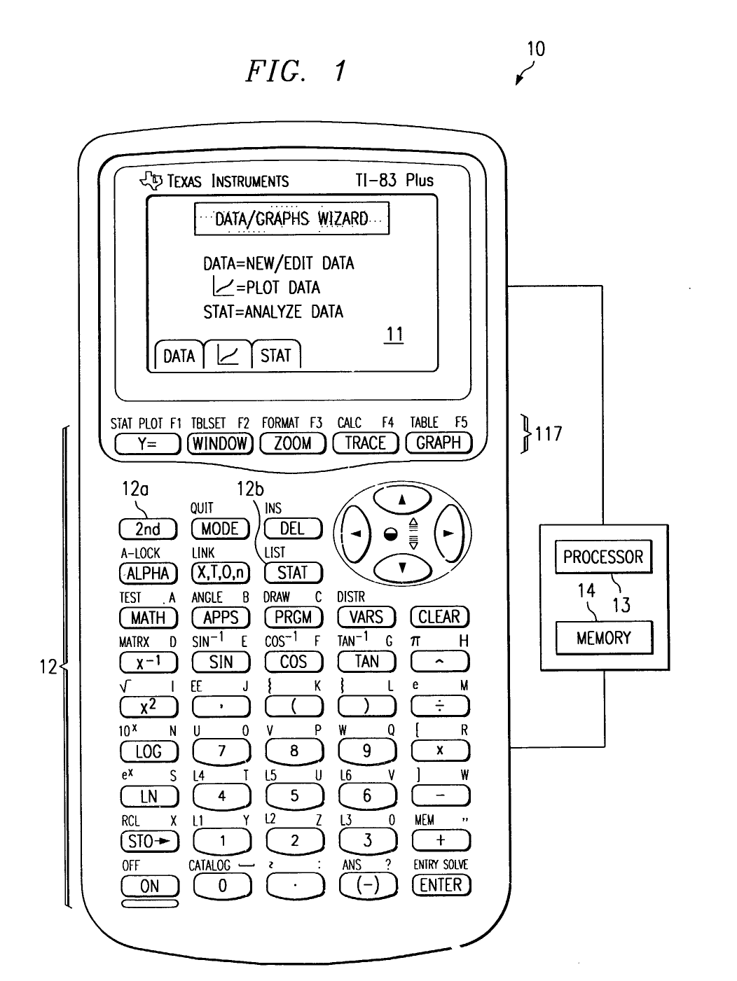

FIG. 1 illustrates the front panel of a calculator 10, which incorporates the features of the present invention. Calculator 10 is described herein in terms of particular software and hardware features of the TI-83+, a commercially available graphing calculator manufactured by Texas Instruments Incorporated. Apart from the features of the present invention, many of the features of calculator 10 described herein are typical of graphing calculators, while other features are unique to the TI-83+ “family” of TI calculators. The use of the TI-83+ is for purposes of description, and does not limit the invention. The features that are the subject of the present invention could be incorporated into other calculators that provide graphical displays, or they could be incorporated into other computer based teaching tools and handheld computers.

In FIG. 1, the screen 11 of calculator 10 has a “graphical display”, as that term is used herein. In addition to the ability to draw graphical displays of various types, some of the software features of calculator 10 include software applications loading and storage, and keystroke programming. It also permits data collection, display and analysis.

Various hardware features include a large pixel screen 11 which is 64×94 pixels. A keypad 12 has various keys for data and command entry, some of which are used to implement the invention and are described herein. The calculator includes a processor 13 connected to a memory unit 14 having a 32K byte RAM and 512K byte application space. Other features are an I/O port for data linking, and a unit-to-unit link cable connection capability.

As is typical of calculators, calculator 10 has a secondary function key, 2nd key 12a, which permits other keys to have two functions. For example, by pressing 2nd key 12a and then STAT/LIST key 12b, the calculator performs the LIST function. For simplicity of explanation herein, a key having two functions is referred to in terms of the function appropriate for the context, i.e., when discussing the LIST function, the STAT/LIST key 12b is referred to as the LIST key 12b. Similarly, calculator 10 has an Alpha key 12c, which when depressed makes the other keys subsequently depressed to input an alpha character.

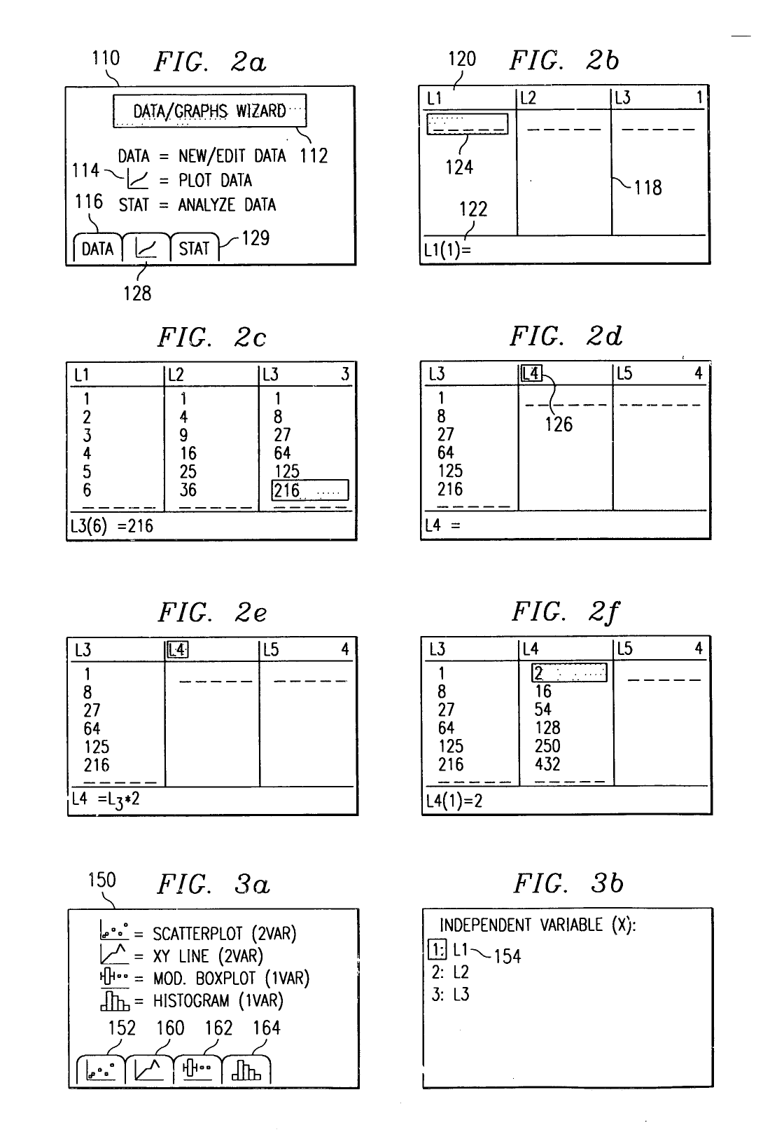

The present invention introduces a user interface and method, which is particularly directed to helping a student in a classroom environment. FIGS. 2a-f illustrate an example of the screen displays of an embodiment of the present invention. This screen displays are for the calculator illustrated in FIG. 1 while running an application program stored in memory 14 by processor 13. An embodiment is a user interface to allow the user to quickly and easily enter, plot and analyze data on a handheld device. The invention introduces a “wizard” user interface that smoothly guides the user through a sequential process of: entering data in one or more lists, viewing the data graphically using one of several common plots, viewing one or more regression functions to fit the data, and analyzing the data using common statistical measures. The invention is applicable and useful for other computer devices such as personal computers, personal data assistants or other hand held electronic devices.

The first screen display of an embodiment of the present invention is the menu display 110 shown in FIG. 2a. The menu display 110 includes a title 112, a list of menu selections 114 and soft keys 116. The soft keys show which of the hard keys 117 on the calculator keyboard located directly below the indicator should be pressed to get the corresponding operation. In this preferred embodiment, the menu has menu selections for data entry, plotting and analyzing. In the preferred embodiment, when the user quits or exits from subsequent screens of any of these menu selections, the program or user interface returns to the menu screen 110.

FIG. 2b shows the screen display after the user presses the key below the “Data” soft key, which starts the “Data=New/Edit Data” menu option. This screen 118 allows the user to edit data in various lists using a list editor. The list editor displays data in a column-and-row format. Each column contains one list of data. The lists are labeled L1, L2, L3, L4, L5, and L6 120 (only 3 lists are shown). The labels can be changed, and more lists can be added to the list editor. Each row in a list contains one data element. The row label and its value are displayed on the entry/edit line 122 at the bottom of the screen. The user is able to enter data into the list element at the current cursor position, the active cell, indicated by the reverse video cursor 124. The cursor is moved in the list editor, from list to list and element to element, with the arrow keys. New entries in the list replace the previous entry.

FIG. 2c show the list editor after entering in data for lists L1, L2, and L3. Note the row label and value for the list element identified by the cursor are shown on the entry/edit line. In this figure, the entry/edit line shows that list 3, item 6 contains the value “216.”

The contents of a list can also be generated using a formula entered at the list header. After entering a formula, the value of each list element is determined from the formula and then inserted into each cell in the list. FIG. 2d show the list editor after moving the cursor to the list header for list L4 126. The entry edit line now shows the contents of the list L4 as empty. The user can then fill the list by inserting a formula with references to another list and arithmetic operators. Pressing 2^{nd} followed by 3 enters the list name L3. Pressing the multiply operator followed by the number 2 results in the formula and display as shown in FIG. 2e. Subsequently pressing the enter key results in the display shown in FIG. 2f. The list L4 is now filled with numbers representing the contents of list L3 times two as shown in FIG. 2f.

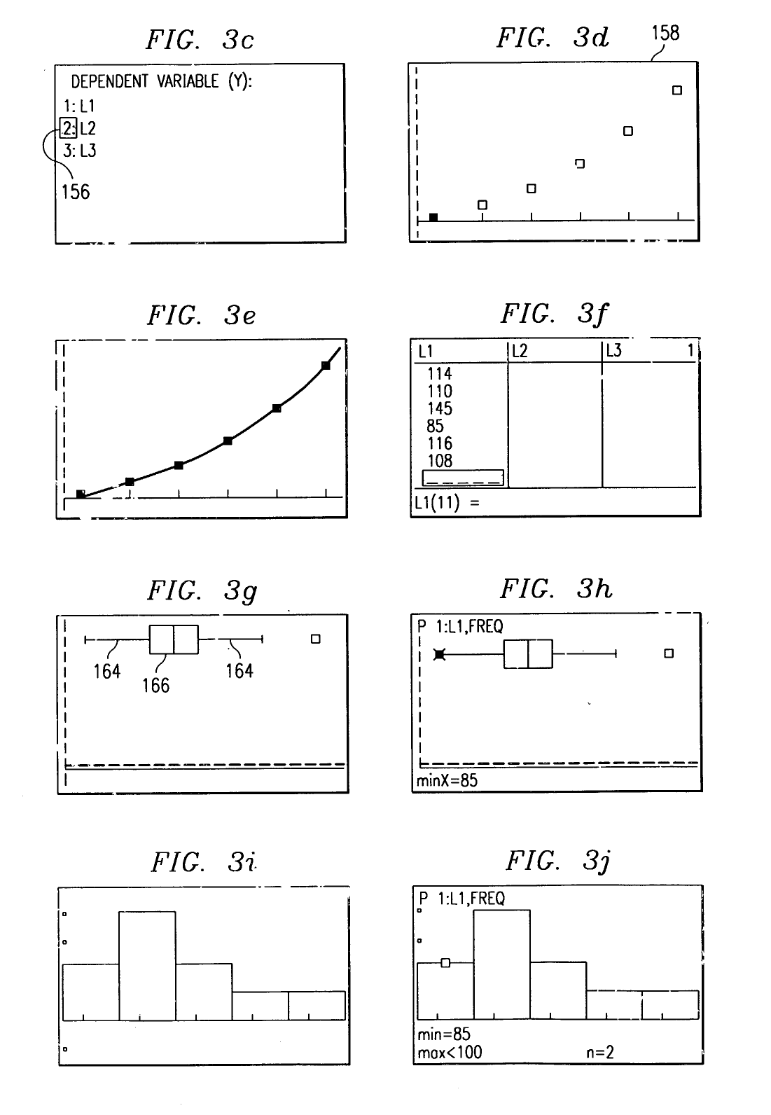

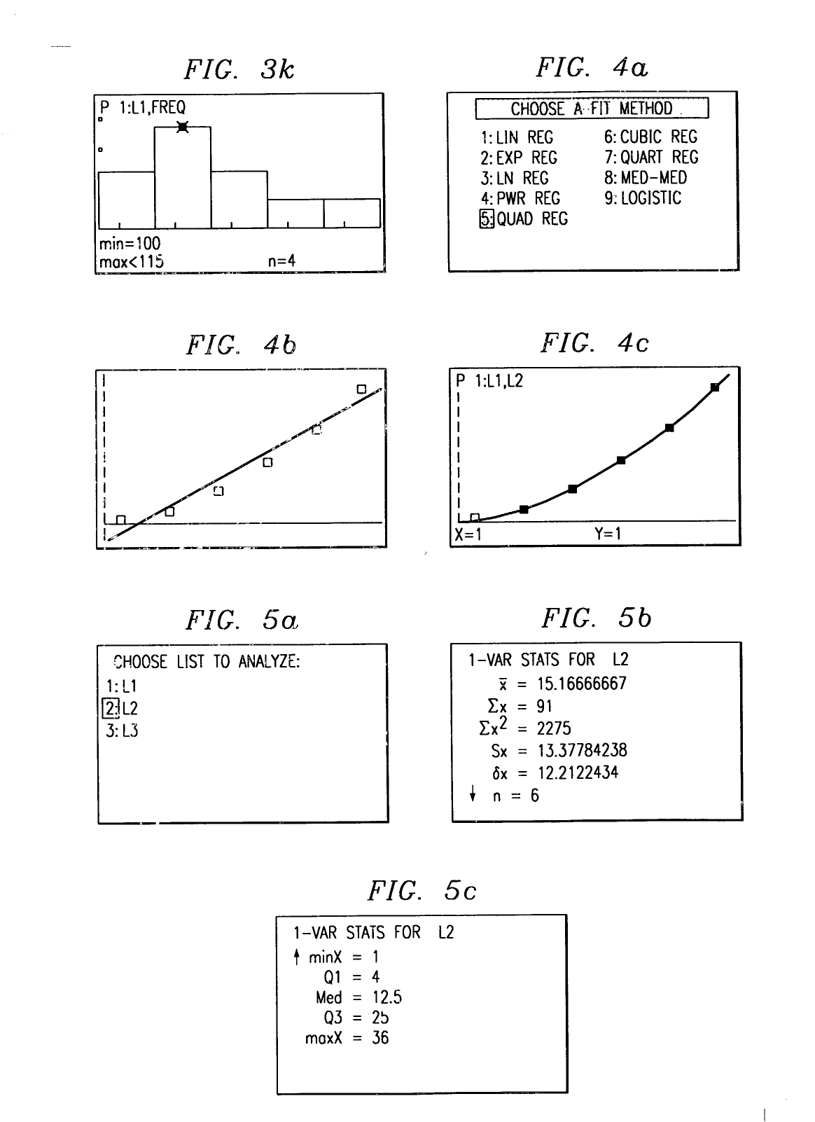

After the user has created one or more lists, the Data/Graphs Wizard allows the student to quickly and easily plot the data. For example, the user presses quit from the screen shown in FIG. 2f to return to the entry screen as shown in FIG. 2a. At this point, the user can now select the plot soft key 128. The plot screen 150 is then displayed as shown in FIG. 3a. The user can now select a plot type by pressing the key corresponding to the soft key for the desired type of plot. There are 4 plot types shown. The first two types require 2 variables and the last two require only 1 variable. The user must define a list for each variable needed by the plot. After selecting the plot type, the user will be asked to enter in the list for each variable.

From the display screen 150 shown in FIG. 3a, pressing the soft key 152 corresponding to scatterplot will result in the screen shown in FIG. 3b. Scatterplot plots the points independently on the graphing screen using two lists to provide the x and y values. The user now can select the list to provide the independent variable for the scatter plot by moving the cursor keys and pressing enter. In this case, the list L1 154 is selected for the independent variable. After pressing enter, the screen shown in FIG. 3c is then displayed. Similarly, the user is allowed to choose the dependent variable for the scatter plot. The list L2 156 is selected by moving the cursor to L2 and pressing “enter.” The scatter plot is then displayed as shown in FIG. 3d.

In a similar way, the user is can easily produce the other plot types from the plot menu 150. From the display screen 150 shown in FIG. 3a, the user can press the soft key 160 to plot an xy line using two lists of data to provide the x and y values. As described above, the user can select the list to provide the independent and dependent variables by moving the cursor keys and pressing enter (not shown). In this case, the list L1 is selected for the independent variable and L2 for the dependent variable. After making these two selections (not shown) and pressing enter, the screen shown in FIG. 3e is then displayed with a line graph with the same data as the scatter plot described above.

The third type of plot in the plot menu 150 is the Modified box plot. From the display screen 150 shown in FIG. 3a, the user can press the soft key 162 to select this plot type. The modified box plot lets the user view the distribution of elements within a single data set. Similar to the previous plot types, the user selects the list to provide the data input by moving the cursor keys and pressing enter (not shown). As an example, FIG. 4a shows a list L1=(12, 92, 104, 132, 114, 110, 145, 85, 116, 108). After selecting modified box plot in screen 150 and then selecting the list L1 (not shown) the screen shown in FIG. 3g is displayed. The minimum and maximum x are shown as the endpoints of the wisker lines 164 coming out of the box 166. The box left and right edges represent the first and third quartile values respectively, and the line dividing the box is the median value of the data set. These values can be observed by pressing the trace key of the calculator as shown in FIG. 3h. The other point values can be determined by moving the cursor to other points on the boxplot using the cursor keys.

The final plot type in the plot menu 150 is the histogram plot. From the display screen 150 shown in FIG. 3a, the user can press the soft key 164 to select this plot type. The histogram lets the user graphically view the distribution of elements within a single data set. Similar to the previous plot types, the user selects the list to provide the data input by moving the cursor keys and pressing enter (not shown). The resulting plot show how many data elements fall within certain equally-spaced intervals. As an example, the data list shown in FIG. 4a is again used. After selecting histogram plot in screen 150 and then selecting the list L1 (not shown) the screen shown in FIG. 3i is displayed. The minimum, maximum and n are shown for each interval by pressing the trace key of the calculator as shown in FIG. 3j. These values for the other intervals can be determined by moving the cursor to the other points on the histogram using the cursor keys as shown in FIG. 3k.

Another feature of the present invention is fitting the graphed data to a regression to see how it fits into a curve. After a scatter plot or an xy line is graphed, the user is requested to choose a fit method. For example, from the screen displayed in FIG. 3d, the user is requested to choose a fit method when exiting this screen. (Other keystrokes may not be recognized to maintain a limited functionality while in the data/graphs wizard.)

FIG. 4a shows 9 fit methods. The LIN REG method displays a linear regression that fits the model y=ax+b to the data using a least squares fit. The EXP REG method displays an exponential regression that fits the model equation y=ab^{x} to the data suing a least-squares fit and transformed values x and ln(y). The PWR REG method displays a linear regression that fits the model y=ax^{b} to the data using a least squares fit and transformed values ln(x) and ln(y). The QUAD REG method displays an exponential regression that fits the second degree polynomial y=ax²+by+c to the data. The CUBIC REG method displays an cubic regression that fits the third degree polynomial y=ax³+bx²+cx+d to the data. The QUART REG method displays a quartic regression that fits the fourth degree polynomial y=ax⁴+bx³+cx²+dx+e to the data. The MED-MED method displays a median-median regression that fits the model equation y=ax+b to the data using the median-median line (resistant line) technique, calculation the summary points for x1, y1, x2, y2, x3 and y3. The LOGISTIC method fits the model equation y=c/(1+a*e^{-bx}) to the data using an iterative least-squares fit.

FIG. 4b illustrates the LIN REG fit method applied to the data plot shown in FIG. 3j. This screen results from exiting from the screen in FIG. 3j, which results in the screen of FIG. 4a, and then choosing the LIN REG method by using the cursor keys and pressing enter. Similarly, using the same data plot and choosing the EXP REG method results in the display as shown in FIG. 4c.

Another feature of an embodiment of the present invention allows the user to analyze the data of a list. The STAT option is the third menu option available on the initial menu screen 110 shown in FIG. 2a. The stat function is activated by pressing the key associated with the STAT soft key 129. The STAT menu option performs statistical calculation on a single data set or list. After pressing the soft key 129 the user must select a list to analyze as shown in FIG. 5a. After pressing enter, the first screen of statistical data is displayed as shown in FIG. 5b. By pressing the down arrow key or other cursor key, the rest of the statistical calculation are displayed as shown in FIG. 5c. The statistical calculations in the illustrated embodiment are a collection of standard statistical values. Other values could also be included. When the user exits from this screen, the user interface preferably returns to the menu screen 110.

Other Embodiments

Although the present invention has been described in detail, it should be understood that various changes, substitutions, and alterations could be made hereto without departing from the spirit and scope of the invention as defined by the appended claims.

The described embodiment of the present invention is an application program on a graphing calculator, which allows the user observe a grid of real-time data and allows the user to easily make changes in the grid data while the program is operating. Similarly, other embodiments include the same user interface functionality in a ROM software application package that is executed on a graphing calculator or other handheld device.

What is claimed is:

1. A software program stored on a computer media for a handheld computer device which provides a simple user interface for entering, plotting and analyzing list data comprising:
a menu display for a user to select an option from a plurality of options;
a data entry/edit option which allows a user to create at least one list of data;
a plot data option which allows the user to view a plot for data entered into at least one list of data with a minimum of key strokes and without setting screen display parameters by simply selecting a plot type, and designating the source list for all variables needed for the selected plot type.

2. The software program of claim 1, further comprising an analyze data option which allows the user to view a plurality of common statistical data calculations on at least one selected list of data.

3. The software program claim 1, wherein the functionality of the handheld computer device is limited to the selection of the plurality of options at the menu display, and limited to a subset of functionality of the handheld computer device when operating one of said plurality of menu options to keep the user in a simple environment to enter, plot and analyze list data.

4. The software program of claim 1, wherein the data entry/edit option further comprises:
a. rows and columns for entry of a plurality of lists of data, with a list for each column; and
b. a list header to identify the list.

5. The software program of claim 1, wherein the plot option further comprises:
a. a plurality of plot types;
b. a graphic indication of each plot type;
c. wherein selection of a plot type is followed by a request for a list to supply the plot variables, and
d. display of the plot immediately follows entry of the selection of the lists to supply the plot variables.

6. A handheld computing device comprising:
a display screen;
an input device for operating the computing device and entering user responses;
a processor for executing programming that provides a user interface to the spreadsheet application wherein the user interface further comprises:
a menu display for a user to select an option from a plurality of options,
a data entry/edit option which allows a user to create at least one list of data,
a plot data option which allows the user to view a plot for data entered into at least one list of data with a minimum of key strokes and without setting screen display parameters by simply selecting a plot type, and designating the source list for all variables needed for the selected plot type.

7. The handheld computing device claim 6, further comprising an analyze data option which allows the user to view a plurality of common statistical data calculations on at least one selected list of data.

8. The handheld computing device claim 6, wherein the functionality of the handheld computer device is limited to the selection of the plurality of options at the menu display, and limited to a subset of functionality of the handheld computer device when operating one of said plurality of menu options to keep the user in a simple environment to enter, plot and analyze list data.

9. The handheld computing device claim 6, wherein the data entry/edit option further comprises:
a. rows and columns for entry of a plurality of lists of data, with a list for each column; and
b. a list header to identify the list.

10. The handheld computing device of claim 6, wherein the plot option further comprises:
a. a plurality of plot types;
b. a graphic indication of each plot type;
c. wherein selection of a plot type is followed by a request for a list to supply the plot variables, and
d. display of the plot immediately follows entry of the selection of the lists to supply the plot variables.

11. A graphing calculator comprising:
a screen capable of displaying spreadsheet rows and columns for a spreadsheet application;
an input device for operating the computing device and entering user responses;
a processor for executing programming that provides a user interface to the spreadsheet application wherein the user interface further comprises:
a menu display for a user to select an option from a plurality of options,
a data entry/edit option which allows a user to create at least one list of data,
a plot data option which allows the user to view a plot for data entered into at least one list of data with a minimum of key strokes and without setting screen display parameters by simply selecting a plot type, and designating the source list for all variables needed for the selected plot type.

12. The graphing calculator claim 11, further comprising an analyze data option which allows the user to view a plurality of common statistical data calculations on at least one selected list of data.

13. The graphing calculator of claim 11, wherein the functionality of the handheld computer device is limited to the selection of the plurality of options at the menu display, and limited to a subset of functionality of the handheld computer device when operating one of said plurality of menu options to keep the user in a simple environment to enter, plot and analyze list data.

14. The graphing calculator of claim 11, wherein the data entry/edit option further comprises:
a. rows and columns for entry of a plurality of lists of data, with a list for each column; and
b. a list header to identify the list.

15. The graphing calculator of claim 11, wherein the plot option further comprises:
a. a plurality of plot types;
b. a graphic indication of each plot type;
c. wherein selection of a plot type is followed by a request for a list to supply the plot variables, and
d. display of the plot immediately follows entry of the selection of the lists to supply the plot variables.
